(19) United States
(12) Patent Application Publication
(10) Pub. No.: US 2008/0104424 A1
(43) Pub. Date: May 1, 2008

(54) Systems and Methods to Reduce Deployment Security Exposure Using WOL

(75) Inventor: Jeffrey B. Jennings, Raleigh, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 11/555,073

(22) Filed: Oct. 31, 2006

(51) Int. Cl. G06F 1/00

(52) U.S. Cl. 713/300

(57) ABSTRACT

Systems, methods and media for timing the receipt and response to WOL packets are disclosed. In one embodiment, timing information concerning when to receive a WOL packet is sent to a target computer. The timing information may also comprise information concerning when to power on in response to a received WOL packet. The target computer evaluates the timing information and receives the WOL packet at the prescribed time and powers on in response thereto at the prescribed time.

### FIELD

The present invention is in the field of networking of computer systems. More particularly, the invention relates to Wake-On-Lan (WOL) protocol to reduce security risks in computer networks.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, and accounting. Further, networks enable high speed communication between people in diverse locations by way of e-mail, websites, instant messaging, and web-conferencing.

A common architecture for high performance, single-chip microprocessors is the reduced instruction set computer (RISC) architecture characterized by a small simplified set of frequently used instructions for rapid execution. Thus, in a RISC architecture, a complex instruction comprises a small set of simple instructions that are executed in steps very rapidly. These steps are performed in execution units adapted to execute specific simple instructions. In a superscalar architecture, these execution units typically comprise load/store units, integer Arithmetic/Logic Units, floating point Arithmetic/Logic Units, and Graphical Logic Units that operate in parallel. In a processor architecture, an operating system controls operation of the processor and components peripheral to the processor. Executable application programs are stored in a computer's hard drive. The computer's processor causes application programs to run in response to user inputs.

Thus, in a modern system, a plurality of computers—including servers—are connected together through a network. In particular, a plurality of computers may be linked together by one or more servers in a Local Area Network (LAN). The computers and servers may typically be connected by an Ethernet. The Ethernet is a large and diverse family of frame-based computer networking technologies for local area networks. Ethernet has been standardized as Institute of Electrical and Electronics Engineers (IEEE) standard IEEE 802.3. Its star-topology, twisted pair wiring form has become the most widespread LAN technology in use from the 1990s to the present, largely replacing competing LAN standards such as coaxial cable. The IEEE standard defines a number of wiring and signaling standards for the physical layer, two means of network access at the Media Access Control (MAC)/Data Link Layer, and a common addressing format. Above the physical layer, Ethernet stations communicate with each other by sending each other data packets, small blocks of data that are individually sent and delivered. As with other IEEE 802 LANs, each Ethernet station is given a single 48-bit MAC address, which is used both to specify the destination and the source of each data packet. Network interface cards (NICs) or chips normally do not accept packets addressed to other Ethernet stations. Adapters generally come programmed with a globally unique address but this can be overridden either to avoid an address change when an adapter is replaced or to use locally administered addresses.

Each computer in a LAN can be individually powered on using Wake On Lan (WOL) methodology. WOL methodology may be used in conjunction with the Dynamic Host Configuration Protocol (DHCP), which is a set of rules used by a communications device (such as a computer, router or networking adapter) to allow the device to request and obtain an Internet address from a server which has a list of addresses available for assignment. The general process of waking a computer up remotely in a LAN can be explained as follows. Initially, the target computer is shut down, with power reserved for the network interface circuitry (NIC). The NIC can be a separate card in the computer or server, or can be circuitry included on the motherboard of the computer or server. The NIC listens for a specific packet, called the Magic Packet. The Magic Packet is broadcast on a particular subnet of the LAN or the entire LAN. The Magic Packet is a broadcast frame that can be sent by a variety of connection protocols. The data that is contained in a Magic Packet is the defined constant as represented in hexadecimal, FF FF FF FF FF FF, followed by sixteen repetitions of the target computer's Media Access Control (MAC) address, possibly followed by a four or six byte password. The listening computer receives this Magic Packet, checks it for the correct information, and then boots if the Magic Packet is valid. Once the computer is booted by its Basic Input-Output System (BIOS), it can receive data, files and programs from the server which caused it to boot using the WOL protocol.

For example, a server may send a WOL packet to boot one or more computers and then send the computers an image of an operating system to be run on the computers. Presently, WOL methodology poses security risks. A hacker may use WOL to remotely boot a computer and image its operating system without authorization. Or a hacker can waken the computer and destroy its hard drive contents by, for example, sending a blank image to the hard drive. A hacker might also use WOL to repeatedly power on and power off computers in the network, thereby creating a debilitating traffic load on the network.

Thus, there is a need for WOL security measures to prevent unauthorized and destructive use of WOL.

### SUMMARY

The present invention provides systems, methods and media for timing receipt of and responses to WOL packets in a computer network environment. In one embodiment, a serving computer (server) generates a WOL packet comprising an address of a computer in the network. The server also generates timing information indicative of when the computer will be responsive to a WOL packet. The server transmits the timing information to the computer to control when the computer will be responsive to a WOL packet. Such a response may include powering on at a prescribed time.

Embodiments include a system for timing responses to Wake On LAN (WOL) packets in a computer network environment. The system comprises a packet generator for generating a WOL packet to be transmitted to a target computing machine (computer). A timing information generator generates timing information indicative of when the computer will be responsive to the WOL packet. A transmitter transmits the timing information to the computer to control when the machine will be responsive to the WOL packet.

Another embodiment of the invention provides a computer program product comprising instructions effective, when executing in a data processing system, to cause the system to perform a series of operations for timing receipt and response to a WOL packet. The series of operations generally include generating a Wake On LAN (WOL) packet to transmit to a computer. The operations also include generating timing information indicative of when the computer will be responsive to a generated WOL packet, and transmitting the timing information to the computer to control when the computer will be responsive to a WOL packet.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a digital system within a network; the digital system can control the receipt and response to WOL packets.

FIG. 2 depicts an embodiment of for generating, timing, transmitting, and receiving of WOL packets.

FIG. 3 depicts a flow chart of an embodiment for timing and transmission of WOL packets.

FIG. 4 depicts a flow chart of an embodiment for receiving and processing of timing information and WOL packets.

### DETAILED DESCRIPTION OF EMBODIMENTS

The following is a detailed description of example embodiments of the invention depicted in the accompanying drawings. The example embodiments are in such detail as to clearly communicate the invention However, the amount of detail offered is not intended to limit the anticipated variations of embodiments; but, on the contrary, the intention is to cover all modifications, equivalents, and alternatives falling within the spirit and scope of the present invention as defined by the appended claims. The detailed description below is designed to render various embodiments obvious to a person of ordinary skill in the art.

Systems, methods and media for timing the receipt and response to WOL packets are disclosed. In one embodiment, timing information concerning when to receive a WOL packet is sent to a target computer. The timing information may also comprise information concerning when to power on in response to a received WOL packet. The target computer evaluates the timing information and receives the WOL packet at the prescribed time and powers on in response thereto at the prescribed time.

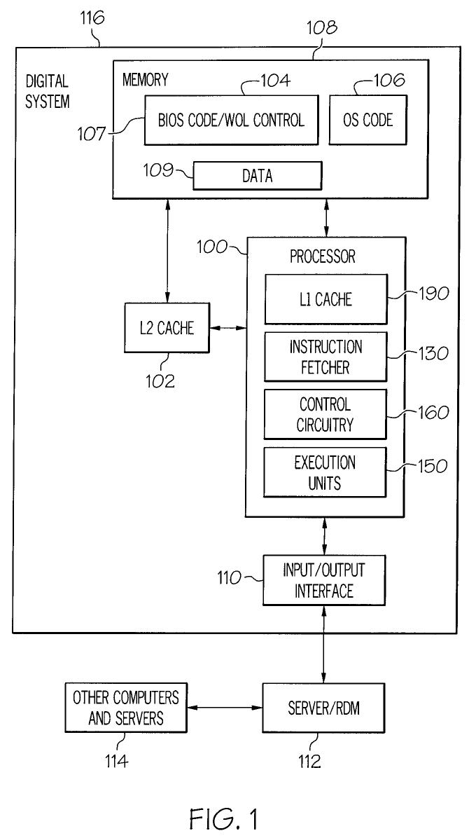

FIG. 1 shows a digital system 116 (herein sometimes referred to as a machine) such as a computer or server implemented according to one embodiment of the present invention. Digital system 116 comprises a processor 100 that can operate according to BIOS (Basis Input/Output System) Code 104 and Operating System (OS) Code 106. In one embodiment, the BIOS includes WOL control functionality as will be described herein. The BIOS and OS code is stored in memory 108. The BIOS code is typically stored on Read-Only Memory (ROM) and the OS code is typically stored on the hard drive of computer system 116. Digital system 116 comprises a level 2 (L2) cache 102 located physically close to processor 100. Memory 108 also stores other programs for execution by processor 100 and stores data 109.

In an embodiment, memory 108 stores computer code 107 to provide WOL control. This computer code may be part of BIOS code or may be separate there from. WOL control computer code processes timing information from a serving computer to determine when to power on in response to a WOL packet. In response to a WOL packet which contains a MAC address of a computer, the addressed computer may power on at a time prescribed by a server that generates and transmits the WOL packet. Once the computer powers on and boots according to BIOS, it may receive data and programs downloaded from the server that broadcast the WOL packet.

For example, a serving computer may prescribe a schedule of times to the computer for receiving and responding to a WOL packet. Alternatively, or in addition, the serving computer may provide a time interval during which a computer is to receive the WOL packet. The timing information received from the server may further comprise a time for responding to the WOL packet after the WOL packet is received. The response may comprise a power on of the computer in order for the computer to receive a program, such as an operating system, transmitted by the serving computer. Thus, in one embodiment, the serving computer may prescribe a window of time during which the target computer 216 may accept WOL packets. The target computer receives the WOL packet during the prescribed time. The target computer will respond by powering on at a prescribed time after the WOL packet is received.

Embodiments contemplate that Network Interface Circuitry (NIC) contained within a target machine will remained powered on when the rest of the computer, namely its central processing unit, will be powered off. The NIC can therefore receive WOL packets and timing information when the computer is powered off. The NIC may be contained on a separate circuit card or may be integrated onto the same circuit board which contains processor 100.

Processor 100 comprises an on-chip level one (L1) cache 190, an instruction fetcher 130, control circuitry 160, and execution units 150. Level 1 cache 190 receives and stores instructions that are near to time of execution. Instruction fetcher 130 fetches instructions from memory. Execution units 150 perform the operations called for by the instructions. Execution units 150 may comprise load/store units, integer Arithmetic/Logic Units, floating point Arithmetic/Logic Units, and Graphical Logic Units. Each execution unit comprises stages to perform steps in the execution of the instructions fetched by instruction fetcher 130. In a superscalar architecture, different execution units operate in parallel.

Thus, execution units 150 comprise a set of units of different types operating in parallel to execute instructions to process WOL control functions. These instructions enable the computer to receive timing information which may include a schedule of times for receiving a WOL packet, and further enable the computer to determine according to the schedule if it is time to receive a WOL packet transmitted by a server. The instructions further enable the computer to determine if it is time to respond to the WOL packet by, for example, powering on.

Control circuitry 160 controls instruction fetcher 130 and execution units 150. Control circuitry 160 also receives information relevant to control decisions from execution units 150. For example, control circuitry 160 is notified in the event of a data cache miss in the execution pipeline to process a stall.

Digital system 116 also typically includes other components and subsystems not shown, such as: a Trusted Platform Module, memory controllers, random access memory (RAM), peripheral drivers, a system monitor, a keyboard, a color video monitor, one or more flexible diskette drives, one or more removable non-volatile media drives such as a fixed disk hard drive, CD and DVD drives, a pointing device such as a mouse, and a network interface adapter, etc.

Digital systems 116 may include personal computers, workstations, servers, mainframe computers, notebook or laptop computers, desktop computers, or the like. Processor 100 may also communicate with a server 112 by way of Input/Output Device 110. Server 112 connects system 116 with other computers and servers 114 and also provides Remote Deployment Manager (RDM) functionality as will be described herein. Thus, digital system 116 may be in a network of computers such as the Internet and/or a LAN. Further, server 112 may control access to other memory comprising tape drive storage, hard disk arrays, RAM, ROM, etc.

Thus, in one mode of operation of digital system 116, the L2 cache receives from memory 108 data and instructions expected to be processed in the processor pipeline of processor 100. L2 cache 102 is fast memory located physically close to processor 100 to achieve greater speed. The L2 cache receives from memory 108 the instructions for a plurality of instruction threads. Such instructions may include load and store instructions, branch instructions, arithmetic logic instructions, floating point instructions, etc. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Each of the units of execution units 150 may be adapted to execute a specific set of instructions. Instructions can be submitted to different execution units for execution in parallel. Data processed by execution units 150 are storable in and accessible from integer register files and floating point register files (not shown.) Data stored in these register files can also come from or be transferred to on-board L1 cache 190 or an external cache or memory. The processor can load data from memory, such as L1 cache, to a register of the processor by executing a load instruction. The processor can store data into memory from a register by executing a store instruction.

A digital system 116 will have its own memory for storing its operating system, BIOS, and the code for executing application programs, as well as files and data. The memory of a computer comprises Read-Only-Memory (ROM), cache memory implemented in DRAM and SRAM, a hard disk drive, CD drives and DVD drives. A server also has its own memory and may control access to other memory such as tape drives and hard disk arrays. Each computer may store and execute its own application programs. Some application programs, such as databases, may reside in the server. Thus, each computer may access the same database stored in a server. In addition, each computer may access other memory by way of a server.

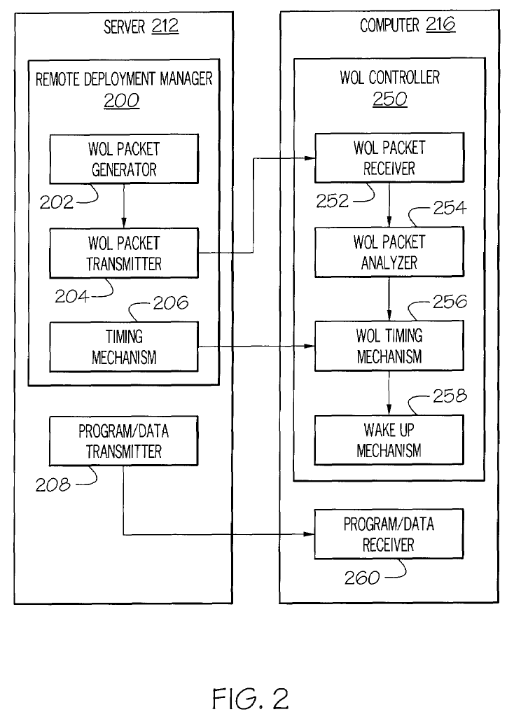

FIG. 2 shows a server 212 in communication with a computer 216 in a (Local Area Network) LAN. The functions shown by the block elements of FIG. 2 are enabled by the execution of instructions by execution units of a processor of the machine. Server 212 comprises a Remote Deployment Manager (RDM) 200 for managing deployment of data and programs such as, for example, an Operating System (OS). In one environment, RDM 200 may deploy operating systems to a plurality of computers substantially simultaneously, or one after another in rapid succession. RDM 200 also controls WOL packet generation and transmission as well as generation and transmission of timing information for timing the receipt and response to WOL packets by computer 216.

Thus, RDM 200 comprises a WOL packet generator 202 to generate WOL packets including magic packets. A magic packet comprises a defined constant represented in hexadecimal, FF FF FF FF FF FF, followed by sixteen repetitions of the target computer's Media Access Control (MAC) address, possibly followed by a four or six byte password, and possibly comprising a pause packet. A password may be included to provide an extra measure of security. The pause packet also provides an extra measure of security. The pause packet is a duration of time between receipt of a WOL packet and response thereto. In an embodiment wherein the WOL packet contains a pause duration, the computer will pause for the specified pause duration after receipt of the WOL packet before powering on.

A WOL packet that WOL packet generator 202 generates is transmitted by a WOL packet transmitter 202. WOL packet transmitter 204 broadcasts the WOL packet to a plurality of, if not all of, the computers in the LAN. Each computer receiving the broadcast WOL packet will analyze it to determine if the transmitted MAC address contained in the transmitted WOL packet matches the MAC address of the computer. Server 212 also comprises a program/data transmitter 208. Transmitter 208 formats and transmits data or one or more programs, such as an operating system, to a target computer to which the WOL packet is addressed. Thus, a WOL packet addressed to a particular computer may cause that computer to power on and boot from the computer's BIOS and receive the data or program(s) that transmitter 208 transmits.

Server 212 also comprises a timing mechanism 206. Timing mechanism 206 presents timing information to a timing mechanism 256 of computer 216. In one embodiment, the timing information comprises certain times to accept a WOL packet. Thus, computer 216 would only accept WOL packets at the specified times. For example, timing information may comprise times 12:05 am, 1:05 am, 2:05 am, etc., i.e., once every hour. In an embodiment, the timing information may comprise a time interval or window during which a WOL packet can be accepted, such as, for example, 12:05 am to 12:10 am. In this case the target computer whose MAC address is contained in the WOL packet will accept WOL packets only during the specified time window.

In another embodiment, each timing mechanism 206 and 256 may comprise a secure identification (ID) chip which generates a number based on a timing algorithm executed by each chip so that authorization to receive a WOL packet occurs only if the numbers generated by each ID chip are the same. In this case, then, the timing information from timing mechanism 206 comprises the number generated by the ID chip of timing mechanism 206. When timing mechanism 256 of computer 216 receives this number, it compares it to the number generated by its own internal ID chip to see if they are the same. If and only then will computer 216 receive a WOL packet and power on in response there to.

In other embodiments, the WOL packet itself may comprise timing information. The WOL packet may comprise a pause period which is a duration of time before which the target system will power on. For example, if the pause period is “100”, the target computer 216 may pause for 100 minutes after receiving the WOL packet before powering on. This delayed WOL technique deprives a hacker from immediate gratification. Thus, in one embodiment, systems 216 that are off for maintenance could be sent a WOL pause packet that would instruct the target system not to power on for a period of time. This can be implemented by appending the WOL packet with a number indicating that the system is not to power on.

In one embodiment a heartbeat signal comprises periodic sending of a WOL pause packet which repeatedly causes the target computer or server to delay power-on for a pause duration. Thus, a single pause WOL packet delays power on for say 5 minutes. At about the expiration of 5 minutes a next pause WOL packet delays power on for another 5 minutes, and so on. This heartbeat signal approach prevents a hacker from taking advantage of a maintenance period.

Computer 216 comprises a WOL controller 250. WOL controller 250 processes WOL packets received from server 212. WOL controller 250 functions are implemented by execution of instructions by execution units of the processor of machine 216. The instructions may be part of the machine's BIOS or may be a set of instructions separate from BIOS. Accordingly, WOL controller 250 comprises a WOL packet receiver 252 to receive a packet that WOL packet transmitter 204 transmits. Packet receiver 252 sends the received packet to a WOL packet analyzer 254.

Packet analyzer 254 evaluates the MAC address that the transmitted WOL packet contains to determine if the MAC address is of the computer 216. Packet analyzer also evaluates the received WOL packet to determine if it contains timing information. For example, a pause packet may prescribe a pause duration for powering on computer 216. Thus, a WOL packet generated by WOL packet generator 202 and transmitted by WOL packet transmitter 204 may prescribe a pause period that delays a power-on time of the receiving computer 216. At the end of the pause period, computer 216 powers on and a program/data receiver 260 of computer 216 receives the program or data that program/data transmitter 206 transmits.

WOL controller 250 also comprises a WOL timing mechanism 256 which is circuitry or software to perform timing functions for security. In one embodiment, timing mechanism 256 receives timing information from timing mechanism 206 of server 212. Alternatively, timing mechanism 256 may receive timing information extracted from a WOL packet by packet analyzer 254. Thus, for example timing mechanism 256 may receive a schedule of times at which to accept WOL packets. Timing mechanism 256 compares a current system time to a scheduled time to determine if it is time to receive a WOL packet. As another example, timing mechanism comprises a timer to time a pause period before accepting a WOL packet. WOL controller 250 further comprises a wake up mechanism 258 responsive to a signal from WOL timing mechanism 256. In response, wake up mechanism 258 causes the power supply of computer 216 to generate and apply power to computer 216. Computer 216 then boots according to BIOS.

Accordingly, a computing system may comprise timing responses to Wake On LAN (WOL) packets in a computer network environment. The system comprises a packet generator for generating a WOL packet to be transmitted to a target computing machine. The system also comprises a timing information generator to generate timing information indicative of when the computing machine will receive a WOL packet and when the machine will be responsive to the WOL packet. The system further comprises a transmitter to transmit the timing information. The system may further comprise a transmitter to transmit data or a program to the computing machine after a time when the computing machine powers on in response to the WOL packet. For example, a server may send a copy of an operating system to the target computer after the machine powers on in response to a WOL packet.

In some embodiments, the system may comprise a number generator to generate a number according to a timing algorithm and to transmit the number to the computing machine for comparison to a number generated by the computing machine according to the same timing algorithm to determine if the WOL packet is authorized. In some embodiments the timing information may comprise a schedule of one or more times when the computing machine will be responsive to a WOL packet. The timing information may comprise an interval of time during which the computing machine will be responsive to a WOL packet. The timing information may comprise a pause period after which the computing machine will be responsive to a WOL packet. The timing information may be contained in a WOL packet or sent separately.

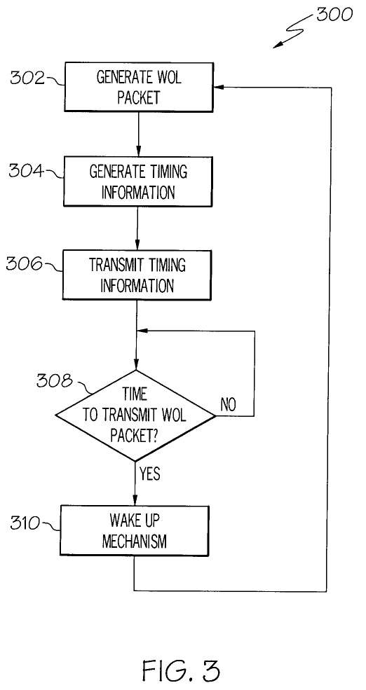

FIG. 3 shows a flow chart 300 of an embodiment for timing and transmission of WOL packets. In this embodiment, the timing information is sent separately from the WOL packet, whereas in alternative embodiments timing information may be included in the WOL packet in addition or instead of timing information sent separately. Initially, the WOL packet for a particular computer is generated (element 302) by a server. The WOL packet contains the address of a target computer and is broadcast to the computers in the LAN. The server also generates timing information concerning when to transmit/receive the WOL packet (element 304). This timing information may include, for example, a schedule of times at which a WOL packet is to be received by the target computer. Or the timing information may include a time interval during which a WOL packet is to be received. The timing information may also include a pause period between the time of receipt of a WOL packet and a time of response to the WOL packet.

The server transmits the timing information to the target computer (element 306). A timing mechanism determines current time and determines if it is time to transmit the WOL packet (element 308). Thus, the timing mechanism may compare the current time to a schedule of times contained in the timing information. If it is not time to transmit the WOL packet, the server continues to monitor the current time and compare the current time to the schedule of times received from the timing information sent by the server. If it is time to transmit the WOL packet, then the server broadcasts the WOL packet (element 310). The target computer receives the WOL packet and responds at the prescribed time. Thus, in one embodiment, the timing information may prescribe a time to respond to the WOL packet after its receipt. The response of the target machine will typically comprise powering on and booting according to the BIOS of the computer. Once the computer is powered on it may download data or programs, such as an operating system, from the server.

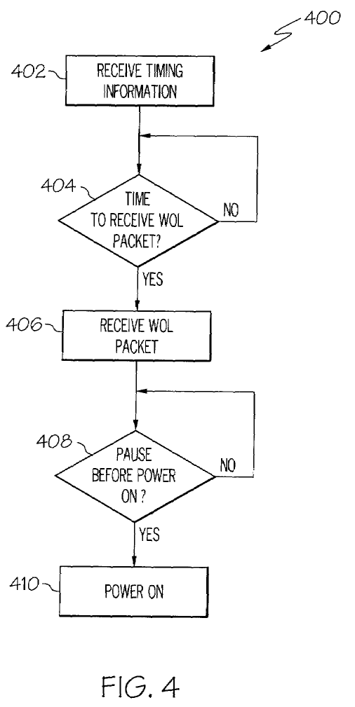

FIG. 4 shows a flow chart 400 of an embodiment for receiving and processing of timing information and WOL packets by a target computer. In this embodiment, a target computer initially receives timing information from a server (element 402). This timing information may comprise a prescribed time to receive the WOL packet and may further comprise a prescribed time to respond to the WOL packet. Thus, from this timing information, the target computer determines if it is time to receive a WOL packet from the server (element 404). If it is not time to receive the WOL packet, then the computer waits until it is time. When it is time to receive the WOL packet, the computer receives it (element 406).

In some embodiments, timing information may be included in the WOL packet itself. Thus, the WOL packet may prescribe a pause duration. The pause duration specifies how long after receipt of the WOL packet the computer will wait before responding to the WOL packet. Based on the timing information the computer receives, the computer decides if it is time to respond by, for example, powering on (element 408). If not time to respond, the computer waits until it is time to respond. When it is time to respond, the computer powers on (element 410). Once the computer powers on it may receive downloads of data or programs from the server.

Thus, some embodiments comprise a method for timing responses to Wake On LAN (WOL) packets in a computer network environment. The method comprises generating a WOL packet comprising an address of a computer in the network and generating timing information indicative of when the computer will be responsive to a WOL packet. The timing information may be included in the WOL packet or sent separately from the WOL packet. The method also comprises transmitting the timing information to the computer to control when the computer will be responsive to a WOL packet. The method may further comprise transmitting a program to the computer after a time when the computer powers on in response to a WOL packet.

The method may yet further comprise generating a number according to a timing algorithm and transmitting the number to the computer for comparison to a number generated by the computer according to the same timing algorithm to determine if a WOL packet is authorized. The timing information may comprise a schedule of one or more times when the computer will receive and/or be responsive to a WOL packet. The timing information may instead comprise an interval of time during which the computer will receive or be responsive to a WOL packet. Alternatively, or in addition, the timing information may be contained in a WOL packet and comprise a pause period after which the computer will be responsive to a WOL packet.

Yet another embodiment is a method for timing responses to Wake On LAN (WOL) packets in a computer network environment, comprising receiving by a computer, timing information comprising a prescribed time to receive a WOL packet. In response, the computer receives a WOL packet at a prescribed time. The computer also receives timing information comprising a prescribed time to respond to a WOL packet. In response, the computer responds to a received WOL packet at the prescribed time. Thus, in one embodiment, the target computer will receive a prescribed one or more times for receiving a WOL packet and will receive one or more prescribed times for responding to the WOL packet.

The invention can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, embodiments can take the form of a computer program product accessible from a machine accessible readable medium providing program code for use by or in connection with a computer such as shown in FIG. 1, or any instruction execution system.

For the purposes of this description, a machine accessible or computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a machine accessible medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory 108 employed during actual execution of the program code, bulk storage, and cache memories 102, 190, which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Thus, another embodiment of the invention provides a computer program product containing instructions effective, when executing in a data processing system, to cause the system to perform a series of operations for controlling the response of a computer to Wake On Lan (WOL) packets. In one embodiment, a computer readable program when executed on a computer causes a serving computer to generate a Wake On LAN (WOL) packet to transmit to a target computer. The serving computer generates tuning information indicative of when the target computer will receive and/or be responsive to a generated WOL packet. The serving computer transmits the timing information to the target computer to control when the target computer will receiver or be responsive to a WOL packet.

The instructions performed by the computer program product may further comprise transmitting a program to the computer after a time when the computer powers on in response to a WOL packet. The instructions may further comprise generating a number according to a timing algorithm and transmitting the number to the target computer for comparison to a number generated by the target computer according to the same timing algorithm to determine if a WOL packet is authorized. The instructions may further comprise scheduling one or more times when the target computer will be responsive to a WOL packet. The instructions may yet further comprise specifying an interval of time during which the target computer will be responsive to a WOL packet. The timing information may comprise a pause period after which the target computer will be responsive to a WOL packet.

Another embodiment of the invention provides a computer program product containing instructions effective, when executing in a data processing system, to cause the system to perform a series of operations for controlling the response of a computer to a Wake On Lan (WOL) packet. The operations comprise receiving timing information comprising a prescribed time for receiving a Wake On LAN (WOL) packet and a prescribed time to respond to the WOL packet. The operations comprise receiving the WOL packet at the prescribed time for receiving the WOL packet, and responding to the WOL packet at the prescribed time for responding to the WOL packet The timing information the computer receives may therefore comprise one or more times for receiving a WOL packet and a schedule of one or more times or a pause duration for responding to a WOL packet.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for timing responses to Wake On LAN (WOL) packets in a computer network environment, comprising:
generating a WOL packet comprising an address of a computer in the network;
generating timing information indicative of when the computer will be responsive to a WOL packet; and
transmitting the timing information to the computer to control when the computer will be responsive to a WOL packet.

2. The method of claim 1, further comprising transmitting a program to the computer after a time when the computer powers on in response to a WOL packet.

3. The method of claim 1, further comprising generating a number according to a timing algorithm and transmitting the number to the computer for comparison to a number generated by the computer according to the same timing algorithm to determine if a WOL packet is authorized.

4. The method of claim 1, wherein generating the timing information comprises generating a schedule of one or more times when the computer will be responsive to a WOL packet.

5. The method of claim 1, wherein generating the timing information comprises generating an interval of time during which the computer will be responsive to a WOL packet.

6. The method of claim 1, wherein generating the timing information comprises generating a pause period after which the computer will be responsive to a WOL packet.

7. The method of claim 1, wherein generating the timing information comprises including the timing information in a WOL packet.

8. A system for timing responses to Wake On LAN (WOL) packets in a computer network environment, comprising:
a packet generator for generating a WOL packet to be transmitted to a target computing machine;
a timing information generator to generate timing information indicative of when the computing machine will be responsive to the WOL packet; and
a transmitter to transmit the timing information to the computing machine to control when the machine will be responsive to the WOL packet.

9. The system of claim 8, further comprising a transmitter to transmit a program to the computing machine after a time when the computing machine powers on in response to the WOL packet.

10. The system of claim 8, further comprising a number generator to generate a number according to a timing algorithm and to transmit the number to the computing machine for comparison to a number generated by the computing machine according to the same timing algorithm to determine if the WOL packet is authorized.

11. The system of claim 8, wherein the timing information generator generates timing information comprising a schedule of one or more times when the computing machine will be responsive to a WOL packet.

12. The system of claim 8, wherein the timing information generator generates timing information comprising an interval of time during which the computing machine will be responsive to a WOL packet.

13. The system of claim 8, wherein the timing information generator generates timing information comprising a pause period after which the computing machine will be responsive to a WOL packet.

14. The system of claim 8, wherein the timing information generator generates timing information contained in a WOL packet.

15. A computer program product comprising a computer useable medium having a computer readable program, wherein the computer readable program when executed on a computer causes the computer to:
generate a Wake On LAN (WOL) packet to transmit to a computer;
generate timing information indicative of when the computer will be responsive to a generated WOL packet; and
transmit the timing information to the computer to control when the computer will be responsive to a WOL packet.

16. The computer program product of claim 15, further comprising transmitting a program to the computer after a time when the computer powers on in response to a WOL packet.

17. The computer program product of claim 15, further comprising generating a number according to a timing algorithm and transmitting the number to the computer for comparison to a number generated by the computer according to the same timing algorithm to determine if a WOL packet is authorized.

18. The computer program product of claim 15, wherein generating the timing information comprises generating a schedule of one or more times when the computer will be responsive to a WOL packet.

19. The computer program product of claim 15, wherein generating the timing information comprises generating an interval of time during which the computer will be responsive to a WOL packet.

20. The computer program product of claim 15, wherein generating the timing information comprises generating a pause period after which the computer will be responsive to a WOL packet.

21. A method for timing responses to Wake On LAN (WOL) packets in a computer network environment, comprising:
receiving timing information comprising a prescribed time to receive a WOL packet;
receiving a WOL packet at a prescribed time;
receiving timing information comprising a prescribed time to respond to a WOL packet; and
responding to a received WOL packet at the prescribed time.

22. A computer program product comprising a computer useable medium having a computer readable program, wherein the computer readable program when executed on a computer causes the computer to:
receive timing information comprising a prescribed time to receive a Wake On LAN (WOL) packet and a prescribed time to respond to the WOL packet
receive the WOL packet at the prescribed time to receive the WOL packet; and
respond to the WOL packet at the prescribed time to respond to the WOL packet.
